(19) United States
(12) Patent Application Publication
(10) Pub. No.: US 2006/0123996 A1
(43) Pub. Date: Jun. 15, 2006

(54) Kitchen appliance comprising a lid

(76) Inventors: Henrik Pavlovic, Slowenlen (SI); Aleksander Sedovsek, Mozirje (SI); Uros Semeja, Smartno ob Paki (SI); Igor Zibret, Smartno ob Paki (SI)

Correspondence Address: Craig J Loest;Bsh Home Appliances Corporation, 100 Bosch Boulevard, New Bern, NC, 28562, US

(21) Appl. No.: 10/541,117

(22) PCT Filed: Dec. 18, 2003
(86) PCT No.: PCT/EP03/14468

§ 371 Date: Nov. 14, 2005

(30) Foreign Application Priority Data
Dec. 30, 2002 (DE) 102-61-370.2

(51) Int. Cl. A21B 7/00

(52) U.S. Cl. 99/348

(57) ABSTRACT

A kitchen appliance comprising a housing (14), a pitcher (22) that can be removed from the housing (14), a driving motor (16) that is disposed inside the housing (14), and a tool shaft (12) of a coupling device (32), which is arranged inside the pitcher (22) and is mounted via a shaft bearing (50). The coupling device (32) is provided with an output coupling (35) that is disposed on the driving motor (16) and an input coupling (37) which is placed on the tool shaft (12) and matches the output coupling (35). The inventive kitchen appliance further comprises a cooling air duct with a port (43) that is located on the housing (14), and a lid (40) that can take in an open position in which the port (43) is open and a closed position in which said port (43) is closed. The lid (40) can be moved into the open position by coupling the input coupling (37) to the output coupling (35).

The invention relates to a kitchen appliance having the features mentioned in the preamble of patent claim 1.

Kitchen appliances often require a cooling device. Smaller devices are predominantly equipped with air cooling by means of a cooling air current which can be readily generated by a fan driven by a driving motor. Effective routing of the cooling air requires an air inlet and an air outlet which are typically disposed on opposite sides of a housing. An example for such a motor-driven kitchen appliance is a domestic mixing and crushing facility. This typically comprises a motor housing with an electric driving motor, and a pitcher which can be placed on top of the housing and in the lower region of which a tool shaft can rotate about a vertical axis. The pitcher which is open at the bottom can normally be removed from the housing together with a pitcher base in order to be able to empty the previously cut-up and/or very finely mixed contents into a receptacle.

Cooling arrangements are known for dissipating the lost heat generated during prolonged operation in the driving motor of a mixing and crushing facility. Thus DE 17 78 820 C3 shows a generic domestic mixing and crushing facility comprising a housing with a driving motor disposed inside it, which operates a blade shaft rotating vertically inside a container. The lower end of the motor shaft is provided with a fan blade for dissipating the lost heat generated in the housing through openings in the floor of the housing.

It is an object of this invention to improve the cooling on a motor-driven electrical appliance, in particular on a generic mixing and crushing facility, of component parts which heat up during operation.

With an electrical appliance having the features mentioned in patent claim 1 this requirement is met in that a lid is provided, which may occupy an open position in which the opening (port) is open, and which may occupy a closed position, in which the opening (port) is closed, and in that the lid can be moved into the open position by coupling the input coupling to the output coupling. Compared to conventional electrical air-cooled appliances with pure motor cooling, the appliance according to the invention is provided with additional cooling for a shaft bearing and/or a coupling disposed between the tool shaft and the output shaft of the driving motor. Since an axially separable coupling of this kind normally exhibits a certain elasticity which is due to the material, heat is generated through flexing action which reduces its service life and which can be effectively dissipated by means of selective air flow routing. Also, heat may develop on a tool shaft equipped with sliding bearings during prolonged operation which is relatively difficult to dissipate due to the one-sided encapsulation of the bearing. Due to the selective air cooling also of this bearing its service life may be increased. The invention provides for the air inlet on top of the housing to be closable. This may be achieved, in particular, by a mechanism which closes an upper opening in the housing between the mounting of the tool shaft and the driving motor. This has the effect that with the pitcher removed, dirt and/or moisture are prevented from entering through the upper air inlet.

One embodiment of the invention envisages that the lid, when in closed position, is kept under tension. This will ensure that the lid is held closed due to the force of the spring as soon as the tool shaft is removed from the housing.

Preferably, due to the force of the spring, the input coupling, as opposed to the output coupling, can be brought into a disengaged position due to the force of the spring. This will ensure that the tool shaft can no longer rotate when it is removed from the housing.

In the closed position the lid covers the output coupling thus preventing any foreign particles, dirt or moisture from entering the housing.

Further, when the lid is in the open position, provision may be made for the cooling air duct to be released for routing cooling air for the driving motor and/or the coupling device and/or the shaft mounting, so that the mentioned components may be optimally cooled during operation.

One embodiment of the invention provides for the opening (port) to be disposed adjacent to the output coupling. This arrangement results in the coupling device being directly exposed to the cooling air current as soon as the tool shaft begins to rotate.

A further embodiment of the invention envisages that a fan is disposed on the driving motor for generating a cooling air current through the cooling air duct. To this end, the fan may be advantageously directly coupled with the motor shaft. In particular, it may be mounted onto an end of the output shaft so that the fan blade rotates at the same speed as the motor and can provide for efficient cooling. The design of the blades and their number and size may define the air throughput for a known motor speed. A preferred position of the fan blade may be on an underside of the driving motor opposite the blade shaft where it can be arranged in a space-saving manner. Typically, the lower shaft end is, at any rate, designed so as to extend out of the motor and is equipped with a bearing so that the fan blade can be arranged without problems between the motor and the mounting of the housing.

Preferably the cooling air duct has a gap between a floor portion of the pitcher and the housing, and an additional opening in the housing remote from the opening (port). Preferably the cooling air enters at the gap, is routed past the shaft bearing and the coupling device, enters the inside of the housing via the opening (port), flows through the driving motor and again leaves the housing via the additional opening. This will ensure effective cooling of all components of the kitchen appliance which heat up in operation.

Preferably the pitcher has a pitcher base and a bearing shield carrying the shaft bearing, whereby the pitcher base can be mounted on the housing via a locking means, preferably a bayonet fixing. The bearing shield can thus be easily fixed so that the tool shaft inside it is stably mounted in the housing.

Further, provision may be made for the pitcher and pitcher base to be mounted via a connection means, preferably a thread, and where the bearing shield is disposed between the pitcher and the pitcher base, when the pitcher is mounted on the pitcher base. The bearing shield and thus the tool shaft are thus stably mounted.

In one embodiment of the invention, provided that the pitcher base is mounted on the housing and the pitcher is not mounted on the pitcher base, provision may be made for the bearing shield together with bearing shaft and input coupling to be moved by means of the tensioned lid in such a way that the input coupling is uncoupled from the output coupling. Thus removal of the pitcher from the pitcher base causes the coupling device to be opened and prevents the exposed tool shaft from rotating.

Preferably an annular gap is formed between the housing and the output coupling. The lid is preferably annularly shaped and linearly movable to and fro from the closed position into the opened position coaxially to the output coupling in the annular gap. Further, provision is preferably made for the lid to have a stop in the closed position and to be positioned flush with the adjacent housing portion and/or the facing end of the output coupling. Thus, when the pitcher and/or the pitcher base have been removed, the lid ensures that the gap is closed and that neither dirt nor moisture can enter.

Further aspects and advantageous developments of the invention will be obvious from the dependent claims and the following description of the FIGUREs.

The invention will now be described in more detail by way of an exemplary embodiment with reference to the enclosed drawings, in which

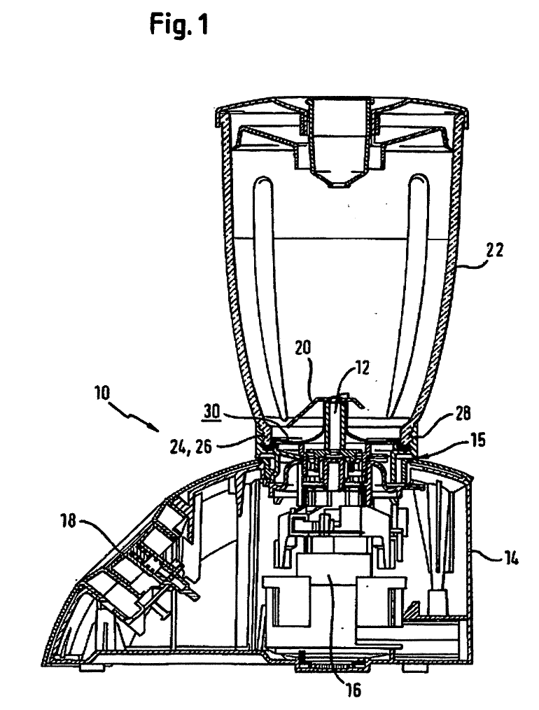

FIG. 1 shows a schematic sectional view of an exemplary kitchen appliance,

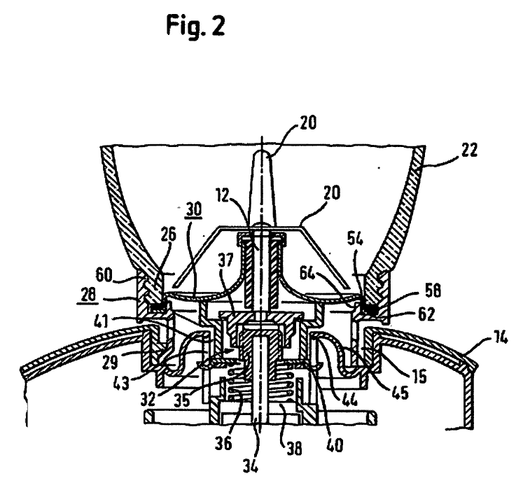

FIG. 2 shows a detail section of the kitchen appliance of FIG. 1 with the pitcher in position,

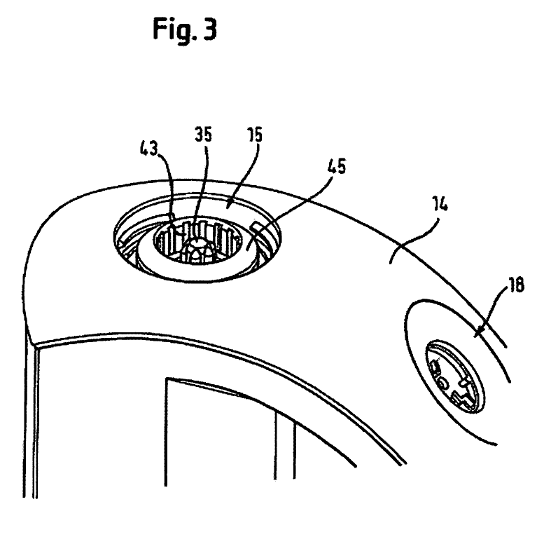

FIG. 3 shows a detail view of a holder for a pitcher base of the pitcher with exposed output shaft,

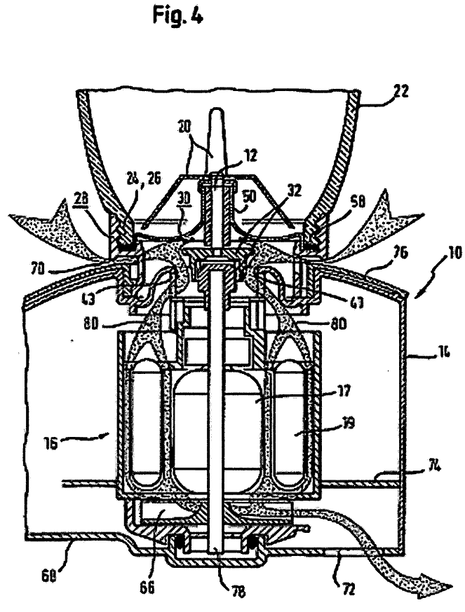

FIG. 4 shows a detail section of a housing of the appliance showing the cooling air current flow,

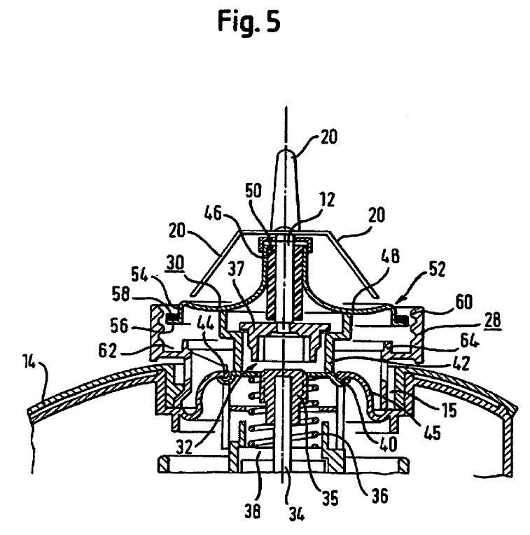

FIG. 5 shows a detail section of FIG. 2 with the pitcher removed,

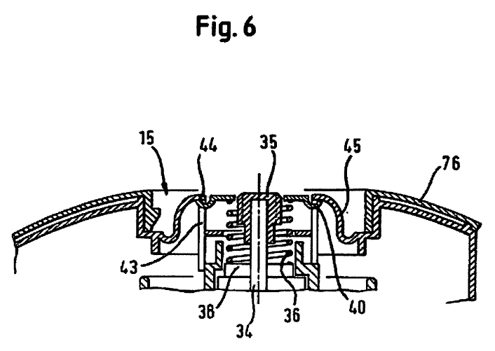

FIG. 6 shows a further detail section of the upper part of the kitchen appliance with the upper air inlets closed, and

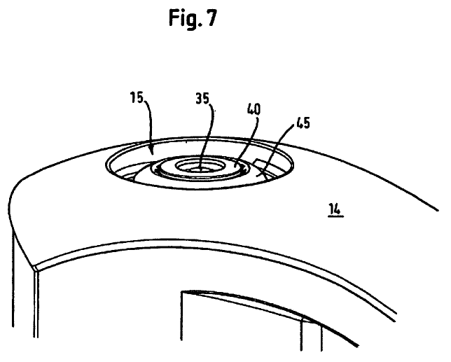

FIG. 7 shows a further detail view of the holder for the pitcher base with substantially flushly shielded output shaft.

FIG. 1 shows a schematically drawn section through a kitchen appliance 10. In the embodiment depicted the kitchen appliance is a so-called mixing and crushing facility which in the following also bears the reference numeral 10. The mixing and crushing facility 10 has a rotating tool shaft 12 and comprises a housing 14 with a driving facility, preferably an electric driving motor 16, arranged inside it as well as a control 18 for performing the functions of the kitchen appliance 10. The tool shaft 12 with blades 20 disposed on it has a vertical rotary axis and protrudes into a pitcher 22 which is fitted and locked into a holder 15 on top of the housing 14 and can be removed again as required. The pitcher 22 has an open floor portion 24 with an annular collar 26 having a cylindrical outer wall surface equipped with an external thread or a bayonet fit etc. This corresponds to a respective internal thread or a respective counter fit of a bayonet locking on a pitcher base 28. The pitcher base 28 can be removed together with the pitcher 22 from the housing 14 and, in that case, seals the open floor portion 24 of the pitcher 22. The pitcher 22 is sealed against the pitcher base 28 by means of an annular seal 58 (compared FIG. 2). When the pitcher 22 is fixedly connected to the pitcher base 28, the tool shaft 12 remains connected to the latter also when the pitcher 22 is removed, since the tool shaft 12 is mounted in a bearing shield 30 fixed between pitcher 22 and pitcher base 28. Preferably the pitcher base 28 may be locked in the holder 15 by means of a bayonet fixing 29.

FIGS. 2 and 5 show a detail section illustrating the construction and the interaction of the essential elements of a start-up safeguard of the kitchen appliance 10. As soon as the pitcher 22 is removed from the pitcher base 28, the tool shaft 12 with its blades 20 anchored in it is exposed (compare FIG. 5). In order to prevent the rotating blades 20 from causing injuries when touched, the driving motor 16 is uncoupled from the tool shaft 12 in this case. To this end a coupling device 32 is provided between the output shaft 34 of the driving motor and the tool shaft 12, which interrupts the frictional connection when the tool shaft 12 moves axially upwards. A spring 36 concentrically arranged about the coupling device 32 is supported, on the one hand against a shoulder 38 of the housing and, on the other against an axially movable lid 40 which is in connection with the bearing shield 30 via a sleeve 42. When the pitcher 22 is removed the spring 36 pushes the lid 40 upwards up to an upper stop 44, which is part of a housing bell 45 of the housing 14. The sleeve 42 sitting on the lid 40 pushes the bearing shield 30 upwards to an extent where the coupling device 32 is separated and the tool shaft 12 is brought out of its engagement with the output shaft 34 of the driving motor 16.

A gap remaining between the housing bell 45 in the holder 15 and the lid 40 serves as a closable port 43 which is closed when the pitcher base 28 or the pitcher 22 is removed. The port 43 is used to provide ventilation to the driving motor 16, which would become very hot when the housing 14 is closed and during prolonged operation. The lost heat may be dissipated with the aid of a ventilation facility which provides for a supply of air through the port 43 and the discharge of the air in the downward direction (compare FIG. 4).

The circularly-shaped bearing shield 30 has a roof-like contour with an inner pipe-shaped portion 46, which has an elongated sliding bearing representing shaft bearing 50 inserted into its section-wise cylindrical internal wall surface, which shaft bearing 50 forms an axial and radial mounting for the tool shaft 12. The bearing shield 30 comprises a joined-up bowl-shaped middle portion 48, against the underside of which the sleeve 42 rests. A joined-up annular outer portion 52 of the bearing shield 30 is shaped in a stepped fashion thus forming a transition from the bowl-shaped middle portion 48 to a short hollow cylindrical portion 54. This portion, on its upper rim, is joined, with a small radius, to the outer rim of the middle portion 48. On the lower rim of the hollow cylindrical portion 54 a disk-like ring 56 is attached which forms a support for the seal 58.

When the pitcher 22 is placed on the pitcher base 28, its collar 26 equipped with an external thread is screwed to the internal thread 60 of the pitcher base 28 (FIG. 2). In this position the lower annular edge on the collar 26 of the pitcher 22 pushes the ring 56 of the bearing shield 30 against the restoring force of the spring 36 in the downward direction, until the ring 56 comes to rest on the bottom of an annular groove 62 of the pitcher base 28. The annular seal 58 ensures that the pitcher 22 is sealed against the pitcher 28 which is closed in the downward direction.

When the pitcher 22 is placed in position, the bearing shield 30 is simultaneously centred in the pitcher base 28. This is preferably achieved by means of a fitting of the inner wall surface of the hollow cylindrical portion 54 on a centring collar 64, which extends upwards on the inner radius of the annular groove 62 and ensures that the bearing shield 30 has a good fit. However, the centring may also be effected between the outer circumference of the ring 56 and the internal thread 60 of the pitcher base 28. At the same time the annular groove 62 forms a stop in axial direction.

In order to ensure that parts of the output shaft 34 are not exposed and cannot be touched when the pitcher 22 is removed, the spring 36 pushes the lid 40 at least so far upwards against the stop 44 of the housing bell 45, that an output coupling 35 connected with the output shaft 34 of the driving motor 16 is exposed only at its facing end. This state is revealed in FIGS. 6 and 7. FIG. 3 shows a detail view of the exposed holder 15 for fitting the pitcher base 28, where for ease of understanding the lid 40 is positioned at its lower stop. This makes it clear that without the upward pushing lid 40 parts of a cylindrical outer wall surface of the output coupling 35 would be freely accessible. The engaging elements arranged on it, which may be brought into engagement with an input coupling 37 of the tool shaft 12 in axial direction, are exposed and could lead to injury when the output shaft 34 is rotated.

As clearly illustrated in FIG. 3 the engaging elements arranged on the cylindrical outer circumference of the output coupling 35 may, in particular, consist of rounded off fins which may engage in correspondingly shaped grooves in the inner wall surface of the input coupling 37. The fins and grooves respectively are preferably arranged exclusively on the wall surface of the respective couplings so that, in particular, the face of the output shaft 35 does not have any steps or projections etc. which could lead to injury when inadvertently touched.

The arrangement according to the invention is characterised by a compact design because the spring 36, which is concentrically arranged about the output shaft 34, and the enveloping housing bell 45 do not require any additional constructional space. The few moving parts ensure reliable and substantially trouble-free functioning.

Due to the closed port 43 neither moisture nor dirt can enter into the interior of the appliance. FIG. 7 also illustrates the relatively flat-shaped and optically pleasing design of the holder 15 with the pitcher base 28 removed.

FIG. 4 illustrates the path of a cooling air current 80 through the kitchen appliance 10, which initially passes through the shaft bearing 50 of the tool shaft 12, through the coupling device 32 and thereafter through the driving motor 16, before it leaves in a downward direction through an air outlet and an additional opening 72 respectively. The cooling air current 80 is generated by a fan 66 which is disposed on a lower end 78 of the motor shaft. The fan 66 causes the axial current to be redirected to become a radial current by sucking air axially from the motor 16 and allowing it to leave in radial direction.

A gap 70 representing an air inlet is provided between housing lid 76 and pitcher base 28, through which gap air is sucked in. The air flows underneath the bearing shield 30 carrying the shaft bearing 50 for the tool shaft 12 and provides for sufficient heat dissipation from this sliding bearing. An annular port 43 is arranged concentrically about the coupling device 32, which port forms a cooling air duct to the driving motor 16. The cooling air current enters through this port 43 and cools the coupling device 32 while passing it, whereby the coupling device 32, due to its elasticity, performs a flexing action and is heated up in the course of it. The air, which is still relatively cool, then passes through the driving motor 16, whereby the cooling air current splits up, as required, between existing gaps, for instance between stator 19 and rotor 17 as is indicated in FIG. 4.

Immediately beneath the motor 16 is the fan 66 sucking in the air, which pushes the air in radial direction towards the outside and through an additional opening 72. In the exemplified embodiment the additional opening 72 representing a floor opening is formed in the housing floor 68. If necessary, the additional opening 72 may be provided with a strainer or grid (not shown) in order to prevent any foreign particles from entering the lower region of the housing and colliding with the fan 66. A partition 74 separates the lower region of the housing from the region further up and prevents the cooling air from flowing past the driving motor 16, since otherwise parts of the air flowing through the port 43 could be sucked in directly by the fan 66, without passing the gaps between rotor 17 and stator 19.

In order to prevent foreign particles from entering into the interior of the motor, when pitcher 22 is removed or pitcher base 28 is removed from its holder 15, the port 43 is shaped so as to be closable in region of the coupling device 32. FIGS. 5 and 6 illustrate the closability of port 43 when the pitcher base 28 is removed. The port 43 is closed by the lid 40 resting against the upper stop 44, so that the housing interior is reliably protected preventing dirt and/or moisture from entering. An annular gap 41 is formed between the housing 14 and the output shaft 35. The lid 40 is also annularly shaped and is linearly movable to and fro from the closed into the opened position in the annular gap 41 coaxially to the output coupling 35.

Due to the effective cooling of all parts heating up during operation, the mixing and crushing facility 10 according to the invention is also suitable for continued operation and for heavy use. Both the shaft bearing 50 of the tool shaft 12 and the coupling device 32 typically consisting of elastic synthetic material are subject to heavy wear, depending upon the operating conditions and thus to a distinct built-up of heat. This build-up of heat may be dissipated from the housing 14 by means of the cooling air current 80 as shown in FIG. 4.

1-14. (canceled)

15. A kitchen appliance comprising:
a housing and a pitcher removably mounted on the housing (14);
a driving motor located in the housing and having an output shaft;
a tool shaft of a coupling device disposed inside the pitcher and mounted via a shaft bearing, which coupling device has an input coupling placed on the tool shaft and which matches the output shaft;
a cooling air duct with a port provided on the housing;
a lid being positionable in an open position, in which the port is open, and a closed position, in which the port is closed, the lid being brought into the open position by coupling the input coupling with the output coupling.

16. The kitchen appliance according to claim 15, wherein the lid is held tensioned by a spring in the closed position.

17. The kitchen appliance according to claim 15, wherein the input coupling can be brought into an uncoupled position compared to the output coupling.

18. The kitchen appliance according to claim 15, wherein the lid when in the closed position, covers the output coupling.

19. The kitchen appliance according to claim 15, wherein in the opened position of the lid the cooling air duct is released for conducting cooling air for at least one of the driving motor and the coupling device and the shaft bearing.

20. The kitchen appliance according to claim 15, wherein the port is disposed adjacent to the output coupling.

21. The kitchen appliance according to claim 15, further comprising a fan arranged on the driving motor generating a cooling air current along a cooling air channel through the housing and through the cooling air duct.

22. The kitchen appliance according to claim 21, wherein the cooling air channel has a gap between a floor portion of the pitcher and the housing and an additional opening in the housing, which is remote from the port.

23. The kitchen appliance according to claim 22, wherein the cooling air enters at the gap, is conducted along the cooling air channel past the shaft bearing and the coupling device, enters the interior of the housing through the port, flows through the driving motor and exits again from the housing through the additional opening.

24. The kitchen appliance according to claim 15, wherein the pitcher has a pitcher base and a bearing shield carrying the shaft bearing, whereby the pitcher base is mountable on the housing via a locking means.

25. The kitchen appliance according to claim 24, wherein the locking means includes a bayonet fixing.

26. The kitchen appliance according to claim 24, wherein the pitcher is mountable on the pitcher base via a connection means, and when the pitcher is mounted on the pitcher base, the bearing shield is disposed between the pitcher and the pitcher base.

27. The kitchen appliance according to claim 26, wherein the connection means includes a thread.

28. The kitchen appliance according to claim 26, wherein, when the pitcher base is mounted on the housing and the pitcher is not mounted on the pitcher base, the bearing shield with bearing shaft and the input coupling is moved by means of the tensioned lid in such a way that the input coupling is uncoupled from the output coupling.

29. The kitchen appliance according to claim 15, wherein an annular gap is formed between the housing and the output coupling and in that the lid is annularly shaped and is linearly movable to and fro from the closed position into the opened position coaxially to the output coupling.

30. The kitchen appliance according to claim 15, wherein the lid has a stop in the closed position and is positioned so as to be flush with at least one of the adjacent housing portion and the facing end of the output coupling.

31. A kitchen appliance comprising:
a housing having a holder near a top portion of the housing;
a pitcher having a bottom edge defining an open floor portion;
a pitcher base removably connected to the pitcher to close the open floor portion, the pitcher base being removably mounted in the holder of the housing;
a driving motor disposed in the housing and having a rotational output shaft extending outwardly the motor and having an output coupling at an end of the output shaft;
a tool shaft connected to the pitcher base for rotation with respect to the pitcher base and having an input coupling at an end of the tool shaft and being engagable with the output coupling to transfer rotation from the output shaft to the tool shaft;
a port defined by the housing near the holder and surrounding the output coupling; and
a ring-shaped lid supported by the housing and surrounding the output coupling, the lid being movable between an open condition, in which the port is open and the input coupling is engaged with the output coupling, and a closed condition, in which the lid closes the port and the input coupling is disengaged from the output coupling.

32. The kitchen appliance according to claim 31, wherein the lid moves toward the open condition in response to the pitcher being connected to the pitcher base and the pitcher base being mounted in the holder of the housing, and the lid moving toward the closed condition in response to at least one of the pitcher being disconnected from the pitcher base and the pitcher base being removed from the holder of the housing.

33. The kitchen appliance according to claim 31, further comprising a biasing member biasing the lid toward the closed condition.

34. The kitchen appliance according to claim 31, wherein the housing includes a housing bell defining the port and limiting axial movement of the lid and stopping the lid in the closed condition, the lid being substantially flush with a top facing end of the output coupling in the closed condition.

35. The kitchen appliance according to claim 31, further comprising a bearing shield connected to the rotor shaft and extending radially outwardly to an outer disc-like ring, the bearing shield being movable between an engaged condition, in which the input coupling engages the out put coupling, and a disengaged condition, in which the input coupling is disengaged from the output coupling, the bottom edge of the pitcher engaging the disc-like ring to move the bearing shield from the disengaged condition to the engaged condition, the lid being in the open condition when the bearing shield is in the engaged condition.
